(19) United States
(12) Patent Application Publication
(10) Pub. No.: US 2014/0262076 A1
(43) Pub. Date: Sep. 18, 2014

(54) STOP FOR GUIDE RAILS ON A BLACKOUT CURTAIN OR SHADE

(71) Applicant: HOMERUN HOLDINGS CORPORATION, Pensasola, FL (US)

(72) Inventors: WILLIS JAY MULLET, GULF BREEZE, FL (US); DANIEL T. MATTHEWS, PENSACOLA, FL (US); RICHARD SCOTT HAND, PACE, FL (US)

(73) Assignee: HOMERUN HOLDINGS CORPORATION, PENSACOLA, FL (US)

(21) Appl. No.: 13/839,190

(22) Filed: Mar. 15, 2013

(51) Int. Cl. E06B 9/42

(52) U.S. Cl. CPC E06B 9/42
USPC 160/295; 160/293.1

(57) ABSTRACT

Embodiments of the invention relate to a stop configured to be positioned in a track channel of a guide rail for guiding a shade. Further embodiments relate to a guide rail and stop combination, where the guide rail and stop combination are configured to be used for guiding a shade. Still further embodiments relate to a shade system incorporating one or more guide rails for guiding a shade and at least one stop positioned with respect to the guide rail to control the travel of bottom bar interconnected with the shade.

### BACKGROUND OF INVENTION

Curtains, shades, or blinds for windows, which can be referred to generally as shades, can be positioned proximate a window for the purpose of optionally blocking light from entering the window. Some shades have a mounting structure that can be positioned proximate the window's frame, and can optionally be mounted to such window frame. These shades can utilize a storage roll that is spring-loaded such that the shade rolls up onto, or into, the storage roll when the shade is open and can be unrolled from the storage roll to close the shade. The closed state of the shade occurs when the shade is extended to cover the window and block light, and preferably block all light, from entering through the window and the open state of the shade occurs when the curtain is retracted onto, or into, the storage roll so light is permitted through the window.

Shade systems including a spring-loaded storage roll operate such that once the curtain is disengaged from the closed state by the user, the spring mechanism can assist with the opening of the curtain by imparting a force upon the shade that encourages movement of the shade toward and into, or onto, the storage roll for storage. Frequently, these shade systems require little or no additional assistance from the user during the shade's transition from closed state to open state. Some shade systems can also incorporate a motor that turns the storage roll to lower or raise the shade.

The shade can incorporate a bottom bar at the distal end of the shade, such that one or both ends of the lower bar, and one or both side edges of the shade travel along within guide rails in operable proximity to the window frame and/or built into the window frame. As the shade rolls up onto, or into, the storage roll and the ends of the bottom bar travel up within the guide rails, the spring or motor turning the storage roll can sometimes cause the end of the bottom bar to raise too far and exit the end of the guide rail. Often guide rails are designed such that the end of the bottom bar will find its way back within the guide rail when the storage roll is then turned so as to lower the shade. Of course, such designs do not work every time and the bottom bar can sometimes get stuck out of the guide rail. Further, even if the bottom bar does find its way back into the guide rail, the motor can be rezeroed incorrectly due to the storage roll turning past where the shade reached the open state, possibly causing the motor to then stop before reaching the closed position when closing the shade as the shade system is designed to turn the storage roll a certain number (whole and/or fraction) of turns to move the shade from the open state to the closed state.

U.S. Pat. No. 4,386,454 (Hopper) teaches an apparatus for assembling, on a mass production basis, shade devices for insulating a building area against heat transmission. Each shade device includes a roller, a plurality of shade sheets attached to the roller to be retracted thereon and detracted therefrom and a plurality of spacer devices mounted with one sheet of each pair of adjacent sheets to space them apart when detracted from the roller. The assembling apparatus comprises a sheet feeding section for ultimately feeding and assembling all of the sheets in generally mutually parallel relation. Other mechanisms place spacer devices in close proximity to each of the sheets on which spacer devices are to be mounted and attachment apparatus associated with the sheet feeding section and spacer device placing mechanisms attach each of the spacer devices to its respective closely proximate sheet. A further mechanism is provided to secure a leading lateral edge of each of the sheets to the roller and to rotate the roller to retract all of the sheets and spacer devices thereon.

U.S. Pat. No. 5,351,738 (Petersen et al.) teaches a roller screen for shielding a window area in a wall or an inclined roof surface, e.g. an insect net, which comprises a spring-biased roller bar at the upper edge of the opening and a bottom bar at the lower edge of a flexible screen web. The bottom bar has guide members slidable in guide rails having at the bottom a locking device for arresting the bottom bar. At either end of the bottom bar, the guide members include a guide member and a subjacent roll pivotally joumalled in the bottom bar so that, from a first position in which it is in axial alignment with the guide member, the roll may be swung to a locking position outside the path of movement of the guide member. The rolls are functionally connected and biased so that the first position and the locking position are stable switch-over positions. At the end of each guide rail, a stop member is mounted in which a lateral cutout is formed at the bottom of a track in axial alignment with the guide rail for receiving and retaining the roll in the locking position.

U.S. Pat. No. 5,351,742 (Lichy) teaches a closure assembly that is adapted to be used with structural members, which has a pair of guides and a closure member which is in mechanical interengagement with the guides so as to permit relative sliding movement in opening and closing the closure. The closure member has a pair of tracking members disposed on opposite edges that may take the form of tape members. These tracking means are retained within the guides. The guides may have secured thereto shoes which are engaged within guide channels secured to frame members so that relative lateral movement between the guides and frames is permitted. A biasing assembly which enhances lateral tension on the closure member may be employed.

U.S. Pat. No. 6,550,739 (Brindisi) teaches an adjustable linear locking assembly, such as may be used in a mounting device or other suitable devices, which assembly allows automatic, substantially continuous adjustment to the linear position of a locking element such as an interface. The assembly may also provide two-way adjustability.

U.S. Pat. No. 6,851,464 (Hudoba et al.) teaches a storm curtain apparatus that includes a curtain having a left side edge, a right side edge, and a bottom. A curtain bar is affixed to the bottom of the curtain. End caps are affixed to each end of the curtain bar and strips are affixed to the side edges of the curtain. A supporting frame includes first and second side guides, a top support and a bottom support affixed to the side guides. Each of the side guides includes a generally rectangularly shaped and longitudinally extending body. Each body of each side guide includes a longitudinally extending curtain track and slot and a longitudinally extending guide track and slot. The curtain is movable between a first, stored, position and a plurality of second, deployed, positions. The edges of the curtain with the strips affixed thereto reside in the curtain tracks and slots and the end caps partially reside in the guide slots.

U.S. Pat. No. 7,950,436 (Mullet et al.) teaches a room darkening screen apparatus including a shade roll. A shade with a first end and a second end is provided wherein the first end is connected with the shade roll and the second end is connected with a bottom bar. A header is connected with the shade roll and a folding rod is connected with the header such that the folding rod, when released from the header, folds the shade.

U.S. Pat. No. 8,016,016 and U.S. Pat. No. 8,276,642 (Berman et al) teaches a trough shade system and method of use for improved support for a roller tube and shade material. The roller tube and wound shade material are located within a support cradle to minimize unwanted deflection by the roller tube and associated wrinkling and deformation of the shade material. Various mechanisms allow the roller tube a limited range of movement within the support cradle. The system is suitable for shading larger areas than other shading systems which rely on roller tubes with fixed supports at the ends.

There are many versions of curtains, shades, and blinds that use side guides and several of the side guides have sealing materials such as brushes and seals to prevent infiltration of debris, insects, etc. However, the curtain, shade, or blind material can still lose engagement with the side guides.

### BRIEF SUMMARY

Embodiments of the invention relate to a stop configured to be positioned in a track channel of a guide rail for guiding a shade. Further embodiments relate to a guide rail and stop combination, where the guide rail and stop combination are configured to be used for guiding a shade. Still further embodiments relate to a shade system incorporating one or more guide rails for guiding a shade and at least one stop positioned with respect to the guide rail to control the travel of bottom bar interconnected with the shade.

Embodiments of the invention can be utilized with systems for covering windows incorporating a curtain, shade, or blind, which can be referred to generally as a shade, that can be positioned proximate a window for the purpose of optionally blocking light from entering the window. Embodiments can incorporate a mounting structure that can be positioned proximate the window's frame, and can optionally be mounted to such window frame. The mounting structure can have a storage roll that is spring-loaded such that the shade rolls up onto, or into, the storage roll when the shade is open and the shade is unrolled from the storage roll to close the shade. The closed state of the shade occurs when the shade is extended to cover the window and block light, and preferably block all light, from entering through the window and the open state of the shade occurs when the curtain is retracted onto, or into, the storage roll so light is permitted through the window.

Embodiments of the subject shade systems including a spring-loaded storage roll can operate such that once the curtain is disengaged from the closed state by the user, the spring mechanism can assist with the opening of the curtain by imparting a force upon the shade that encourages movement of the shade toward and into, or onto, the storage roll for storage. Preferably, the shade system requires little or no additional assistance from the user during the shade's transition from closed state to open state.

Further embodiments of the subject shade system incorporate a motor that turns the storage roll to lower or raise the shade. The motor can be controlled manually by engaging a mechanism to trigger the motor to raise and/or lower (open and/or close) the shade. In an embodiment, a button is used to trigger the motor to close or open the shade. The button can be a toggle type, switch, where one direction is open and the other is close, a click-type button where a click opens the shade and a further click closes the shade.

Embodiments can be configured to work with shades incorporate a bottom bar at the distal end of the shade, such that one or both ends of the lower bar travel within the guide rail, which is in operable proximity to the window frame and/or built into the window frame. In preferred embodiments, designed to seal out essentially all light when the shade is closed, one or both side edges of the shade also travel within the guide rail when the shade opens and closes. As the shade rolls up onto, or into, the storage roll and the end of the bottom bar travel up within the guide rail, the spring or motor turning the storage roll are prevented from causing the end of the bottom bar to raise too far and exit the top end of the guide rail.

By preventing the bottom bar from exiting the top of guide rail in embodiments using a motor, the motor can be prevented from being rezeroed incorrectly due to the storage roll turning past where the shade reached the open state. In particular, such that the motor will tend to be rezeroed at the proper position when the shade is in the open position. In an embodiment, the shade system can be designed such that, when the open command is received, the shade is opened until the bottom bar contacts the stop. In this way, the bottom bar stops at the same position each time the shade is opened, the stop can be used as a reference point for the motor control software to rezero the position counter, and the motor can be rezeroed, where rezeroing occurs at the same position each time. Accordingly, the motor will then stop at the same position when reaching the closed position each time, as the shade system is designed to turn the storage roll a certain number (whole and/or fraction) of turns to move the shade from the open state to the closed state.

A stop, or preferably a pair of stops, can be located in a side guide rail. The shade system can have a pair of side guide rails, and a curtain (e.g., “blackout” curtain), shade, or a blind. The stop can allow the shade to pass and prevent the bottom bar of the shade from passing. When two stops are used on the same guide rail, in a specific embodiment, the side edge of the shade can pass between the two stops, which are positioned on opposite sides of the guide rail. Embodiments of the stop can be installed, or adjusted, during installation of the shade or after the shade is in operation, which can allow insertion of the bottom bar into the guide rail prior to installing the stop.

Embodiments of the stops can be attached to the guide rails in a variety of manners, so as to control the upper travel limit of the shade by, for example, preventing further motion of the shade's hem bar, or bottom bar, inside the side channel.

An embodiment of the stop can be adjustable such that the stop can be positioned at one of a plurality of positions along the length of the guide rail.

A set screw can be incorporated with the stop, such that the set screw pushes the legs of the set pinch apart, driving the legs into the interior walls of the guide rail.

### BRIEF DESCRIPTION OF DRAWINGS

FIG. 1 is a perspective view of a curtain, shade, or blind assembly in accordance with an embodiment of the subject invention mounted over an opening.

FIG. 2 is a perspective view of a curtain, shade, or blind assembly in accordance with an embodiment of the subject invention mounted over an opening with the curtain, shade, or blind in the closed or “blackout” position.

FIG. 3 is an enlarged perspective view of the curtain, shade, or blind in the fully open position with the bottom bar against the stops.

FIG. 4 is a top view of an embodiment showing a side guide and two stops.

FIG. 5 is an enlarged perspective view of FIG. 4 with an Allen wrench used for locking the position of the stops shown positioned in the set screw.

FIG. 6 is an enlarged exploded perspective view of the components of the stop guide track assembly.

FIG. 7 is a perspective view of the assembly with the front cover removed, viewed from below to shoe relationship of the shade with the bottom against the stop in the guide track.

### DETAILED DISCLOSURE

A specific embodiment of the subject invention will now be described to illustrate certain features of the subject invention. FIG. 1 shows a shade assembly 1 with the guide rails, or side guides, 3 and sill 4 in the installed position in an opening 2 in a structure, where the shade is in the open position.

In FIG. 2, the shade assembly 1 with side guide rail, or guide rail, 3 and sill 4 is in the installed position in opening 2 in a structure and the shade 6 is covering the opening in a closed position.

FIGS. 3-6 show a stop 8 positioned in a stop position and attached to the guide rail 3. Another stop can, optionally, be positioned and attached to the side guide on the other side of shade 6. In this embodiment, the two guide rails are two portions of the same guide rail 3. Alternatively, two separate guide rails can be used. The stop 8 is positioned in the channel 10 of the guide rail 3 and secured, or locked, into position. In specific embodiments, the stop can be locked into position by tightening the set screw 9. In a specific embodiment, the set screw can be an Allen screw that can be tightened with Allen wrench 11. Turning the set screw into the threaded hole 14 can widen the gap 7 in the stop 8, expanding the stop to reach out and make frictional contact with the inner surface of channel 10 and/or frictional contact with the tips 13 of the channel walls 16.

The guide rail 3 can also have seal 12 in the channel 10, as shown in FIG. 6, to further assist in preventing light or debris intrusion into the structure.

The shade can have shade material 6, with one edge 6a of the shade material attached to a storage roll 20 or some other structure for lifting the shade material 6, and the opposite edge of the shade material attached to a bottom bar 5. The other two edges 6a, 6b (6b not shown) of the shade material are traversing, or side, edges located in opposing side guides. When the storage roll 20, or other structure for the shade material, is activated, the storage roll pulls the shade material up, lifting the bottom bar 5 up, where the side edges 6a are traveling in the stop guides. The ends 5a, 5b (5b not shown) of the bottom bar 5 are also extending sufficiently into the guide rails to prevent the ends of the bottom bar from moving to be in front or behind the side guide. A stop 8 can be attached to the guide rail 3 such that as the shade material is lifted the end 5a of the bottom bar 5 will meet the stop 8. The stop is sufficiently secured with respect to the side guide to stop the upward movement of the shade when the bottom bar contacts the stop.

The stop 8 shown in FIGS. 1-6 is an expandable stop that is positioned and secured to the side guides with set screws. Other mechanisms for positioning and securing the stop can also be employed.

Aspects of the invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, transient and non-transient media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.
1 The shade or blind unit
2 Opening
3 Side guides
4 Sills
5 Bottom bar
6 Shade or blind material
6a Edge of shade material
7 Gap in stop
8 Stop
9 Setscrews
10 Track channel
11 Allen wrench
12 Seals
13 End brackets
14 Threaded holes
15 Tips of channel walls
16 Channel walls
20 Storage roll

1. A shade apparatus, comprising:
a shade;
a bottom bar attached to a distal end of the shade, wherein the bottom bar has a first end and a second end;
a lift mechanism, wherein the lift mechanism is coupled to a proximal end of the shade and configured to raise and lower the shade;
a first guide rail, wherein the first guide rail has a first front side portion and a first back side portion; and
a second guide rail, wherein the second guide rail has a second front side portion and a second back side portion,
wherein the shade has a first side edge and a second side edge, opposite each other and running between the proximal end and distal end, wherein a first distal end portion of the first side edge is positioned between the first front side portion and the first back side portion, wherein a second distal end portion of the second side edge is positioned between the second front side portion and the second back side portion, wherein as the shade is raised or lowered the first end of the bottom bar remains positioned between the first front side portion and the first back side portion and the second end of the bottom bar remains between the second front side portion and the second back side portion;
a first stop, wherein the first stop is connected to the first guide rail such that the first stop is above the first end of the bottom bar, wherein the first stop prevents the first end of the bottom bar from passing above a first desired level when the shade is raised,
a second stop, wherein the second stop is connected to the second guide rail such that the second stop is above the second end of the bottom bar, wherein the second stop prevents the second end of the bottom bar from passing above the second stop when the shade is raised.

2. The apparatus according to claim 1, further comprising an additional first stop and an additional second stop,
wherein the first stop is connected to the first front side portion such that the first stop is above the first end of the bottom bar, wherein the additional first stop is connected to the first back side portion such that the additional first stop is above the first end of the bottom bar, wherein the first stop and the additional first stop prevent the first end of the bottom bar from passing above the first desired level when the shade is raised,
wherein the second stop is connected to the second front side portion such that the second stop is above the second end of the bottom bar, wherein the additional second stop is connected to the second back side portion such that the additional second stop is above the second end of the bottom bar, wherein the second stop and the additional second stop prevent the second end of the bottom bar from passing above the second desired level when the shade is raised.

3. The apparatus according to claim 2, wherein the first stop is positioned in a first front channel of the first front side portion, wherein the additional first stop is positioned in a first back channel of the first back side portion, wherein the second stop is positioned in a second front channel of the second front side portion, wherein the additional second stop is positioned in a second back channel of the second back side portion.

4. The apparatus according to claim 2, wherein the first stop, the second stop, the additional first stop, and the additional second stop are expandable stops with a gap in the stop and an opening for a setscrew such that when the setscrew is screwed into the opening, the set screw causes expansion of the gap until the expandable stop is held in place in the corresponding channel.

5. The apparatus according to claim 4, wherein the set screw accepts a screw drive selected from the group consisting of: a hex drive, a slotted drive, a cruciform drive, and a tamper-resistant drive.

6. The apparatus according to claim 1, wherein the lift mechanism comprises a motor.

7. The apparatus according to claim 6, wherein the motor is controlled by motor control software, wherein the motor control software is capable of detecting when the first end of the bottom bar contacts the first stop and the second end of the bottom bar contacts the second stoop, wherein the motor control software is configured when the bottom bar is at the desired level.
